(19) United States
(12) Patent Application Publication
(10) Pub. No.: US 2008/0019265 A1
(43) Pub. Date: Jan. 24, 2008

(54) Systems and methods for configuring a network to include redundant upstream connections using an upstream control protocol

(76) Inventors: Paul Alluisi, Raleigh, NC (US); Matt Sannipoli, Wake Forest, NC (US); Mayasandra Srikrishna, Raleigh, NC (US)

Correspondence Address: ARENT FOX LLP, 1050 CONNECTICUT AVENUE, N.W., SUITE 400, WASHINGTON, DC, 20036, US

(21) Appl. No.: 11/488,182

(22) Filed: Jul. 18, 2006

(51) Int. Cl. G06F 11/00; H04J 3/14; H04L 12/28

(52) U.S. Cl. 370/225; 714/1; 370/254

(57) ABSTRACT

A network includes a primary upstream node associated with a predetermined type of traffic, and a secondary upstream node that is associated with the predetermined type of traffic and is communicatively coupled to the primary upstream node. The network also includes a plurality of traffic nodes communicatively coupled to the primary upstream node and to the secondary upstream node, and each of the plurality of traffic nodes includes a plurality of ports. The primary upstream node is configured to transmit a plurality of periodic indicator messages to each of the plurality of traffic nodes and to the secondary upstream node indicating that the primary upstream node currently is operating as a master upstream node for the network with respect to the predetermined type of traffic. Moreover, for each of the plurality of traffic nodes, a port of the plurality of ports that receives a most recent one of the plurality of periodic indicator messages from the master upstream node is configured to operate as a master upstream port for the traffic node with respect to the predetermined type of traffic.

### BACKGROUND OF THE INVENTION

1. Field of the Invention

The present invention relates generally to systems and methods for configuring a network to include redundant upstream connections using an upstream control protocol. In particular, the present invention is directed towards systems and methods in which an upstream control protocol is used by a master upstream node in a network to inform traffic nodes in the network that it currently is the master upstream node, and the master upstream node transmits messages to the traffic nodes in the network that allow for selective, dynamic reassignment of a master upstream port of the traffic nodes in response to a change in the network, e.g., in response to a failure in the network.

2. Description of Related Art

One known Ethernet network includes a plurality of nodes, e.g., switches, routers, and servers, and each of the nodes include a plurality of ports. For each node, some of the ports may be connected to other nodes in the network (these ports are referred to as “upstream” ports in the present application), and the remainder of the ports may be connected to a subscriber/end-user side of the Ethernet network (the ports are referred to as “downstream” ports in the present application. When a node receives an Ethernet frame, the node forwards the Ethernet frame based upon a destination MAC address field value in the received Ethernet frame. For example, if the MAC address field value is a known value, i.e., the node has learnt the port on which the MAC address field value resides, then the node simply will unicast the received Ethernet frame over the learnt port. However, if the MAC address field value is an unknown value, i.e., the node has not yet learnt the port on which the MAC address field value resides, then the node simply will broadcast the received Ethernet frame over all of its ports with the expectation that only the port associated with the MAC address field value will respond to the Ethernet frame, at which point the previously unknown MAC address field value becomes known to the node. All other ports will discard the Ethernet frame.

However, because different ports of a node may be connected to or coupled to different subscribers/end-users, when the node broadcasts the Ethernet frame over all of its ports, one user's data packets may be forwarded to another user (assuming the received data packet is from a subscriber/end-user), which could thereby create security issues, for example.

To address at least these issues, in another known Ethernet network, a forced upstream forwarding method may be employed with respect to at least some of the nodes in the network, which prevents subscriber/end-user ports from communicating with each other. Specifically, those nodes in the network that employ the forced upstream forwarding method may include at least one master upstream port, and each master upstream port may be associated with at least one type of traffic. For example, in an exemplary node, a first port may be the master upstream port for video traffic, a second port may be the master upstream port for voice traffic, and a third node may be the master upstream port for Internet traffic. In this exemplary node, when the node receives an Ethernet frame associated with video traffic, the node automatically transmits the Ethernet frame via the first port (the master upstream port for video traffic). Similarly, when the node receives an Ethernet frame associated with voice traffic, the node automatically transmits the Ethernet frame via the second port (the master upstream port for voice traffic), and when the node receives an Ethernet frame associated with Internet traffic, the node automatically transmits the Ethernet frame via the third port (the master upstream port for Internet traffic). In this sense, the nodes that employ the forced upstream forwarding method merely has to recognize the type of traffic included in the Ethernet frame, and do not have to determine the end destination of the Ethernet frame. Instead, the decision regarding the end destination of the Ethernet frame generally is made at a higher-level node within the network.

However, in this known Ethernet network employing a forced upstream forwarding method with respect to at least some of the nodes in the network, the master upstream ports are statically selected, i.e., the master upstream ports do not change unless a user intervenes and changes one or more of the master upstream ports. Consequently, when there is failure within the network that affects one of the master upstream ports, e.g., there is a failure associated with one of the master upstream ports, there is a failure associated with a node connected to or communicatively coupled to the one of the master upstream ports, or the like, the transmission of traffic from the master upstream port affected by the failure is delayed until the failure is fixed.

### SUMMARY OF THE INVENTION

Therefore, a need has arisen for systems and methods for configuring a network that overcome these and other shortcomings of the related art, as well as accomplishing other goals. An advantage of the present invention is that a master node in a network may employ an upstream control protocol to create redundant upstream connections within the network. Specifically, each master upstream port associated with a traffic node may be dynamically reassigned during operation of the network in response to changes within the network, e.g., in response to a failure within the network, in response to the master upstream port being busy, or the like.

In an embodiment of the present invention, a network comprises a primary upstream node associated with a predetermined type of traffic, e.g., voice traffic, video traffic, data traffic, Internet traffic, or the like, and a secondary upstream node associated with the predetermined type of traffic, in which the secondary upstream node is communicatively coupled, e.g., via wired, wireless, fiber optic links, to the primary upstream node. The network also comprises a plurality of traffic nodes communicatively coupled to the primary upstream node and to the secondary upstream node, and each of the plurality of traffic nodes comprises a plurality of ports. The primary upstream node is configured to transmit a plurality of periodic indicator messages to each of the plurality of traffic nodes and to the secondary upstream node indicating that the primary upstream node currently is operating as a master upstream node for the network with respect to the predetermined type of traffic. Specifically, the master upstream node is configured to receive all or substantially all packets of information within the network that are associated with the predetermined type of traffic, such that the master upstream node operates as an exit node for the network with respect to the predetermined type of traffic. Moreover, for each of the plurality of traffic nodes, a port of the plurality of ports that receives a most recent one of the plurality of periodic indicator messages from the master upstream node is configured to operate as a master upstream port for the traffic node with respect to the predetermined type of traffic, and all or substantially all packets of information that are associated with the predetermined type of traffic and that are transmitted by the traffic node are transmitted via the master upstream port. Because for each of the plurality of traffic nodes the port that receives the most recent indicator message from the master upstream node is selected as the master upstream port with respect to the particular type of traffic, the network is able to determine that there are no failures or other network problems associated with the master upstream port, e.g., otherwise, the master upstream port would not have been able to receive the indicator message from the master upstream node.

In another embodiment of the present invention, a network comprises a first upstream node, a second upstream node communicatively coupled to the first upstream node, and a traffic node communicatively coupled to the first upstream node and to the second upstream node. The traffic node comprises a plurality of ports, and the first upstream node is configured to transmit a plurality of periodic indicator messages to the traffic node and to the second upstream node indicating that the first upstream node currently is operating as a master upstream node for the network. Moreover, a port of the plurality of ports that receives a most recent one of the plurality of periodic indicator messages from the master upstream node is configured to operate as a master upstream port for the traffic node. For example, the master upstream node may be configured to receive all or substantially all packets of information within the network that are associated with a predetermined type of traffic, such that the master upstream node operates as an exit node for the network with respect to the predetermined type of traffic. Moreover, all or substantially all packets of information that are associated with the predetermined type of traffic and that are transmitted by the traffic node may be transmitted via the master upstream port.

In yet another embodiment of the present invention, a network comprises a master upstream node, and a traffic node communicatively coupled to the master upstream node. Specifically, the traffic node comprises a plurality of ports, the master upstream node is configured to transmit a plurality of periodic messages to the traffic node, and a port of the plurality of ports that receives a most recent one of the plurality of periodic messages from the master upstream node is configured to operate as a master upstream port for the traffic node. For example, the master upstream node may be configured to receive all or substantially all packets of information within the network that are associated with a predetermined type of traffic, such that the master upstream node operates as an exit node for the network with respect to the predetermined type of traffic. Moreover, all or substantially all packets of information that are associated with the predetermined type of traffic and that are transmitted by the traffic node may be transmitted via the master upstream port.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 is a block diagram of an exemplary network according to an embodiment of the present invention.

FIG. 2 is a flowchart of an exemplary method of configuring a network to include redundant upstream connections using an upstream control protocol, according to an embodiment of the present invention.

### DETAILED DESCRIPTION OF PREFERRED EMBODIMENTS

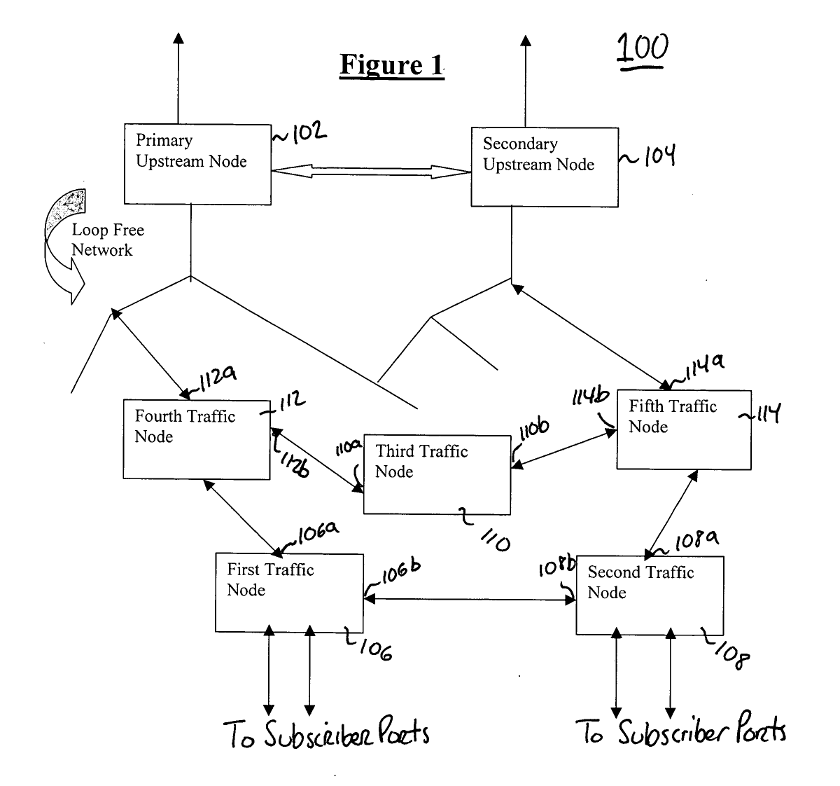

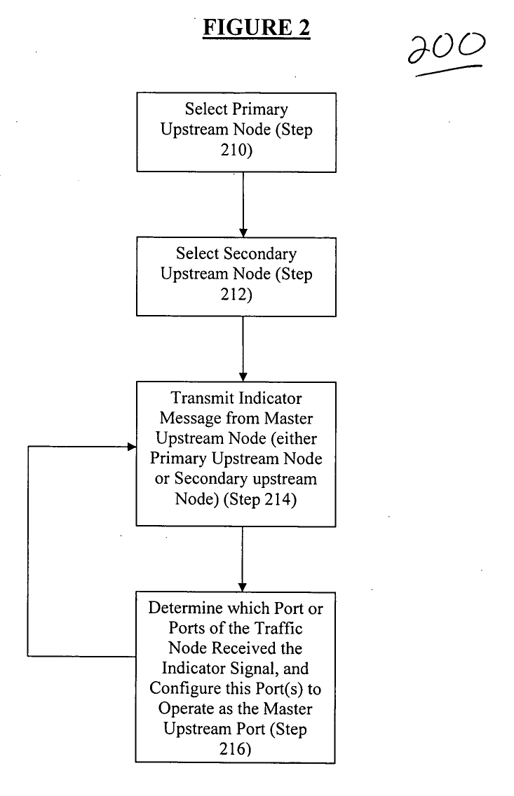

Preferred embodiments of the present invention and their features and advantages may be understood by referring to FIGS. 1 and 2, like numerals being used for like corresponding parts in the various drawings.

Referring to FIG. 1, a network 100, e.g., a virtual local area network (“VLAN”), an Ethernet network, and/or an Internet network, according to an exemplary embodiment of the present invention is depicted. Network 100 may comprise a plurality of nodes, e.g., switches, routers, servers, and/or the like. For example, network 100 may comprise a primary upstream node 102 that may be associated with a predetermined type of traffic, e.g., voice traffic, video traffic, data traffic, Internet traffic, or the like, and a secondary upstream node 104 that may be associated with the predetermined type of traffic, which is communicatively coupled to primary upstream node 102. For example, primary upstream node 102 and a secondary upstream node 104 may be selected by a user from a plurality of available nodes. In an exemplary embodiment of the present invention, network 100 may comprise a plurality of primary upstream nodes and a plurality of secondary upstream nodes, such that network 100 includes a primary-secondary upstream node pair for each of type of traffic that traverses through network 100. For example, a first primary upstream node and a first secondary upstream node may be associated with voice traffic, a second primary upstream node and a second secondary upstream node may be associated with video traffic, a third primary upstream node and a third secondary upstream node may be associated with data traffic, and a fourth primary upstream node and a fourth secondary upstream node may be associated with Internet traffic. However, those of ordinary skill in the art readily will understand that network 100 may include any number of primary-secondary upstream node pairs.

Referring again to FIG. 1, network 100 also may comprise a plurality of traffic nodes. For example, FIG. 1 depicts that network 100 may comprises a first traffic node 106, a second traffic node 108, a third traffic node 110, a fourth traffic node 112, and a fifth traffic node 114. However, those of ordinary skill in the art readily will understand that network 100 may include any number of traffic nodes, and such networks generally include substantially more than five traffic nodes. Moreover, in operation, primary upstream node 102 and secondary upstream node 104 may perform the same or similar functions that are performed by the traffic nodes in the network in addition to performing functions that are unique to the primary upstream node and the secondary upstream node. Each of the traffic nodes included in network 100 may comprise a plurality of ports, and each of the traffic nodes may be communicatively coupled to primary upstream node 102 and secondary upstream node 104. For example, first traffic node 106 may include a first port 106a and a second port 106b, second traffic node 108 may include a first port 108a and a second port 108b, third traffic node 110 may include a first port 110a and a second port 110b, fourth traffic node 112 may include a first port 112a and a second port 112b, and fifth traffic node 114 may include a first port 114a and a second port 114b. Although the traffic nodes depicted in FIG. 1 each include pair of ports, those of ordinary skill in the art readily will understand that the traffic nodes may include any number of ports, and such traffic nodes generally include substantially more than a pair of ports. For example, in one exemplary embodiment of the present invention, each traffic node includes about four hundred ports.

In operation, traffic nodes 106-114 each may employ a forced upstream forwarding method. Specifically, in a forced upstream forwarding method, each of the traffic nodes includes at least one master upstream port, i.e., one master upstream port or a plurality of master upstream ports, associated with a particular type of traffic, and all or substantially all packets of information that are associated with the particular type of traffic and that are transmitted from the traffic node are transmitted from the traffic node via the master upstream port(s). Consequently, each of the traffic nodes merely has to recognize the type of traffic included in the packet, and do not have to determine the end destination of the packet.

However, in contrast to known forced upstream forwarding methods, in the present invention, an upstream control protocol may be employed to allow each master upstream port associated with a traffic node to be dynamically reassigned during operation of the network in response to changes within the network, e.g., in response to a failure within the network, in response to the current master upstream port being busy, or the like.

For example, referring to FIG. 1, primary upstream node 102 may be configured to transmit periodic indicator messages to secondary upstream node 104 and to each of traffic nodes 106-114. The indicator message indicates that primary upstream node 102 currently is operating as a master upstream node for network 100 with respect to the particular type of traffic, i.e., primary upstream node 102 currently is the node that should receive all packets of information within network 100 that are associated with the particular type of traffic, such that primary upstream node 102 currently operates as an exit node for network 100. When primary upstream node 102 transmits the indicator message to traffic nodes 106-114, each of traffic nodes 106-114 receives the indicator message on one of its plurality of ports. In operation, which ever one of the plurality of ports receives the most recent indicator message from primary upstream node 102 is configured to operate as the master upstream port for the traffic node with respect to the particular type of traffic, i.e., all packets of information that are associated with the particular type of traffic and that are transmitted from the traffic node are transmitted from the traffic node via the master upstream port.

For example, with respect to traffic node 106, when primary upstream node 102 transmits a first indicator message, traffic node 106 may receive the first indicator message on port 106a. Consequently, traffic node 106 knows that port 106a currently is the master upstream port with respect to the predetermined type of traffic. Moreover, port 106a continues to operate as the master upstream port for traffic node 106 with respect to the predetermined type of traffic until traffic port 106 receives an indicator message from primary upstream node 102 on a port other than port 106a. For example, if traffic node 106 receives a second, a third, a fourth and a fifth indicator message on port 106a, and then receives a sixth indicator message on port 106b, port 106b will operate as the master upstream port with respect to the predetermined type of traffic after traffic node 106 receives the sixth indicator message on port 106b. Port 106b then continues to operate as the master upstream port for traffic node 106 with respect to the predetermined type of traffic until traffic port 106 receives an indicator message from primary upstream node 102 on a port other than port 106b.

As described above, primary upstream node 102 may be configured to transmit periodic indicator messages to secondary upstream node 104 and to each of traffic nodes 106-114, and the indicator message indicates that primary upstream node 102 currently is operating as the master upstream node for network 100 with respect to the particular type of traffic. However, during operation, there may be network failures that affect primary upstream node 102 and that prevent primary upstream node 102 from effectively operating as the master upstream node with respect to the particular type of traffic. Therefore, in one embodiment of the present invention, secondary upstream node 104 is configured to operate as the master upstream node with respect to the particular type of traffic when primary upstream node 102 is not able to operate as the master upstream node with respect to the particular type of traffic.

For example, in one embodiment, when secondary upstream node 104 receives an indicator message from primary upstream node 102 and then a predetermined amount of time expires without secondary upstream node 104 receiving another indicator message from primary upstream node 102, secondary upstream node 104 may take over as the master upstream node with respect to the particular type of traffic. Specifically, when the predetermined amount of time expires without secondary upstream node 104 receiving another indicator message from primary upstream node 102, it is likely that there is a failure that is preventing primary upstream node 102 from operating as the master upstream node for network 100 with respect to the particular type of traffic.

In another embodiment, secondary upstream node 104 may be configured to transmit periodic status messages to primary upstream node 102, and primary upstream node 102 may be configured to transmit a response to such status messages indicating that primary upstream node 102 still is operating as the master upstream node for network 100 with respect to the particular type of traffic. However, if primary upstream node 102 fails to timely respond to one of the status messages, or if primary upstream node 102 transmits a response to one of the status messages indicating that primary upstream node 102 is unable to operate as the master upstream node with respect to the particular type of traffic, then secondary upstream node 104 may take over as the master upstream node with respect to the particular type of traffic. In any of these embodiments of the present invention, when secondary upstream node 104 takes over as the master upstream node with respect to the particular type of traffic, secondary upstream node 104 performs all of the functions formerly performed by primary upstream node 102. Moreover, when primary upstream node 102 is again able to operate as the master upstream node with respect to the particular type of traffic, secondary upstream node 104 will receive an indicator message from primary upstream node 102 and/or a response to a status message from primary upstream node 102, and primary upstream node 102 will resume operation as the master upstream node with respect to the particular type of traffic.

Referring to FIG. 2, a method 200 of configuring a network, e.g., network 100, to include redundant upstream connections is depicted. For example, a processing system may be configured to execute a software arrangement, and when the processing system executes the software arrangement, the processing system may be configured to perform the steps of method 200. With respect to method 200, in step 210, a primary upstream node, e.g., node 102, associated with a predetermined type of traffic may be selected from a plurality of nodes, e.g., nodes 102-114, and in step 212, a secondary upstream node, e.g., node 104, associated with the predetermined type of traffic may be selected from the plurality of nodes, e.g., nodes 102-114. The secondary upstream node is communicatively coupled to the primary upstream node, and a remainder of the plurality of nodes not selected as the primary upstream node or the secondary upstream node comprise a plurality of traffic nodes, e.g., nodes 106-114, communicatively coupled to the primary upstream node and to the secondary upstream node.

Moreover, in step 214, an indicator message is transmitted from the primary upstream node to each of the plurality of traffic nodes and to the secondary upstream node indicating that the primary upstream node currently is operating as a master upstream node for the network with respect to the predetermined type of traffic. Specifically, the master upstream node is configured to receive all packets of information within the network that are associated with the predetermined type of traffic, such that the master upstream node operates as an exit node for the network with respect to the predetermined type of traffic. If the primary upstream node is not able to operate as the master upstream node with respect to the particular type of traffic, then the secondary upstream node is configured to operate as the master upstream node with respect to the particular type of traffic until the primary upstream node is again able to operate as the master upstream node with respect to the particular type of traffic.

In step 216, for each of the traffic nodes, it is determined which port or ports received the indicator message from the master upstream node. Specifically, all packets of information that are associated with the predetermined type of traffic and that are transmitted from the traffic node are transmitted via the master upstream port. The method then returns to step 214. In this manner, the master upstream port for each of the traffic nodes may be dynamically reassigned during operation of the network in response to changes within the network, e.g., in response to a failure within the network, in response to the current master upstream port being busy, or the like.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A network, comprising:
a primary upstream node associated with a predetermined type of traffic;
a secondary upstream node associated with the predetermined type of traffic, wherein the secondary upstream node is communicatively coupled to the primary upstream node; and
a plurality of traffic nodes communicatively coupled to the primary upstream node and to the secondary upstream node, wherein:
each of the plurality of traffic nodes comprises a plurality of ports;
the primary upstream node is configured to transmit a plurality of periodic indicator messages to each of the plurality of traffic nodes and to the secondary upstream node indicating that the primary upstream node currently is operating as a master upstream node for the network with respect to the predetermined type of traffic; and
for each of the plurality of traffic nodes, at least one port of the plurality of ports that receives a most recent one of the plurality of periodic indicator messages from the master upstream node is configured to operate as a master upstream port for the traffic node with respect to the predetermined type of traffic, wherein all packets of information that are associated with the predetermined type of traffic and that are transmitted by the traffic node are transmitted via the master upstream port.

2. The network of claim 1, wherein the master upstream node is configured to receive all packets of information within the network that are associated with the predetermined type of traffic, such that the master upstream node operates as an exit node for the network with respect to the predetermined type of traffic.

3. The network of claim 2, wherein the predetermined type of traffic is selected from the group consisting of voice traffic, video traffic, data traffic, and Internet traffic.

4. The network of claim 2, wherein the secondary upstream node is configured to transmit a plurality of periodic status messages to the primary upstream node, and when the primary upstream node fails to timely respond to a most recent one of the periodic status messages or the primary upstream node transmits a failure message to the secondary upstream node in response to the most recent one of the periodic status messages, the secondary upstream node is configured to transmit the plurality of periodic indicator messages to each of the plurality of traffic nodes indicating that the secondary upstream node currently is operating as the master upstream node for the network with respect to the predetermined type of traffic.

5. The network of claim 4, wherein when a predetermined amount of time expires after the secondary upstream node receives one of the plurality of periodic indicator messages from the primary upstream node without the secondary upstream node receiving a subsequent one of the plurality of periodic indicator messages from the primary upstream node, the secondary upstream node is configured to transmit the plurality of periodic indicator messages to each of the plurality of traffic nodes indicating that the secondary upstream node currently is operating as the master upstream node for the network with respect to the predetermined type of traffic.

6. A method of configuring a network to include redundant upstream connections, wherein the network comprises a plurality of nodes, and each of the nodes comprise a plurality of ports, the method comprising:
selecting a primary upstream node associated with a predetermined type of traffic from the plurality of nodes;
selecting a secondary upstream node associated with the predetermined type of traffic from the plurality of nodes, wherein the secondary upstream node is communicatively coupled to the primary upstream node, and a remainder of the plurality of nodes not selected as the primary upstream node or the secondary upstream node comprise a plurality of traffic nodes communicatively coupled to the primary upstream node and to the secondary upstream node;
transmitting a plurality of periodic indicator messages from the primary upstream node to each of the plurality of traffic nodes and to the secondary upstream node indicating that the primary upstream node currently is operating as a master upstream node for the network with respect to the predetermined type of traffic;
for each of the plurality of traffic nodes, designating at least one port of the plurality of ports that receives a most recent one of the plurality of periodic indicator messages from the master upstream node as a master upstream port for the traffic node with respect to the predetermined type of traffic; and
at each of the plurality of traffic nodes, transmitting all packets of information that are associated with the predetermined type of traffic via the master upstream port.

7. The method of claim 6, further comprising:
at the master upstream node, receiving all packets of information within the network that are associated with the predetermined type of traffic, such that the master upstream node operates as an exit node for the network with respect to the predetermined type of traffic.

8. The method of claim 7, wherein the predetermined type of traffic is selected from the group consisting of voice traffic, video traffic, data traffic, and Internet traffic.

9. The method of claim 7, further comprising:
at the secondary upstream node, transmitting a plurality of periodic status messages to the primary upstream node;
at the secondary upstream node, determining whether the primary upstream node failed to timely respond to a most recent one of the periodic status messages or whether the primary upstream node transmitted a failure message in response to the most recent one of the periodic status messages; and
at the secondary upstream node, transmitting the plurality of periodic indicator messages to each of the plurality of traffic nodes indicating that the secondary upstream node currently is operating as the master upstream node for the network with respect to the predetermined type of traffic when the primary upstream node fails to timely respond to the most recent one of the periodic status messages or when the primary upstream node transmitted the failure message in response to the most recent one of the periodic status messages.

10. The method of claim 9, further comprising:
at the secondary upstream node, determining whether a predetermined amount of time expired after the secondary upstream node received one of the plurality of periodic indicator messages from the primary upstream node without the secondary upstream node receiving a subsequent one of the plurality of periodic indicator messages from the primary upstream node; and
at the secondary upstream node, transmitting the plurality of periodic indicator messages to each of the plurality of traffic nodes indicating that the secondary upstream node currently is operating as the master upstream node for the network with respect to the predetermined type of traffic after the expiration of the predetermined amount of time.

11. A software arrangement, which, when executed by a processing system, is operable to configure a network to include redundant upstream connections, wherein the network comprises a plurality of nodes, and each of the nodes comprise a plurality of ports, wherein the processing system is operable to:
select a primary upstream node associated with a predetermined type of traffic from the plurality of nodes;
select a secondary upstream node associated with the predetermined type of traffic from the plurality of nodes, wherein the secondary upstream node is communicatively coupled to the primary upstream node, and a remainder of the plurality of nodes not selected as the primary upstream node or the secondary upstream node comprise a plurality of traffic nodes communicatively coupled to the primary upstream node and to the secondary upstream node;
transmit a plurality of periodic indicator messages from the primary upstream node to each of the plurality of traffic nodes and to the secondary upstream node indicating that the primary upstream node currently is operating as a master upstream node for the network with respect to the predetermined type of traffic;
for each of the plurality of traffic nodes, designate at least one port of the plurality of ports that receives a most recent one of the plurality of periodic indicator messages from the master upstream node as a master upstream port for the traffic node with respect to the predetermined type of traffic; and
at each of the plurality of traffic nodes, transmit all packets of information that are associated with the predetermined type of traffic via the master upstream port.

12. The software arrangement of claim 11, wherein the master upstream node is configured to receive all packets of information within the network that are associated with the predetermined type of traffic, such that the master upstream node operates as an exit node for the network with respect to the predetermined type of traffic.

13. The software arrangement of claim 12, wherein the predetermined type of traffic is selected from the group consisting of voice traffic, video traffic, data traffic, and Internet traffic.

14. The software arrangement of claim 12, wherein the processing arrangement is further operable to:
at the secondary upstream node, transmit a plurality of periodic status messages to the primary upstream node;
at the secondary upstream node, determine whether the primary upstream node failed to timely respond to a most recent one of the periodic status messages or whether the primary upstream node transmitted a failure message in response to the most recent one of the periodic status messages; and
at the secondary upstream node, transmit the plurality of periodic indicator messages to each of the plurality of traffic nodes indicating that the secondary upstream node currently is operating as the master upstream node for the network with respect to the predetermined type of traffic when the primary upstream node fails to timely respond to the most recent one of the periodic status messages or when the primary upstream node transmitted the failure message in response to the most recent one of the periodic status messages.

15. The software arrangement of claim 14, wherein the processing arrangement is further operable to:
at the secondary upstream node, determine whether a predetermined amount of time expired after the secondary upstream node received one of the plurality of periodic indicator messages from the primary upstream node without the secondary upstream node receiving a subsequent one of the plurality of periodic indicator messages from the primary upstream node; and
at the secondary upstream node, transmit the plurality of periodic indicator messages to each of the plurality of traffic nodes indicating that the secondary upstream node currently is operating as the master upstream node for the network with respect to the predetermined type of traffic after the expiration of the predetermined amount of time.

16. A network, comprising:
a first upstream node;
a second upstream node communicatively coupled to the first upstream node; and
a traffic node communicatively coupled to the first upstream node and to the second upstream node, wherein:
the traffic node comprises a plurality of ports;
the first upstream node is configured to transmit a plurality of periodic indicator messages to the traffic node and to the second upstream node indicating that the first upstream node currently is operating as a master upstream node for the network; and
a port of the plurality of ports that receives a most recent one of the plurality of periodic indicator messages from the master upstream node is configured to operate as a master upstream port for the traffic node.

17. The network of claim 16, wherein the master upstream node is configured to receive all packets of information within the network that are associated with a predetermined type of traffic, such that the master upstream node operates as an exit node for the network with respect to the predetermined type of traffic, and wherein all packets of information that are associated with the predetermined type of traffic and that are transmitted by the traffic node are transmitted via the master upstream port.

18. The network of claim 17, wherein the predetermined type of traffic is selected from the group consisting of voice traffic, video traffic, data traffic, and Internet traffic.

19. The network of claim 17, wherein the second upstream node is configured to transmit a plurality of periodic status messages to the first upstream node, and when the first upstream node fails to timely respond to a most recent one of the periodic status messages or the first upstream node transmits a failure message to the second upstream node in response to the most recent one of the periodic status messages, the second upstream node is configured to transmit the plurality of periodic indicator messages to the traffic node indicating that the second upstream node currently is operating as the master upstream node for the network.

20. The network of claim 19, wherein when a predetermined amount of time expires after the second upstream node receives one of the plurality of periodic indicator messages from the first upstream node without the second upstream node receiving a subsequent one of the plurality of periodic indicator messages from the first upstream node, the second upstream node is configured to transmit the plurality of periodic indicator messages to the traffic node indicating that the second upstream node currently is operating as the master upstream node for the network.

21. A network, comprising:
a master upstream node; and
a traffic node communicatively coupled to the master upstream node, wherein the traffic node comprises a plurality of ports, the master upstream node is configured to transmit a plurality of periodic messages to the traffic node, and a port of the plurality of ports that receives a most recent one of the plurality of periodic messages from the master upstream node is configured to operate as a master upstream port for the traffic node.

22. The network of claim 21, wherein the master upstream node is configured to receive all packets of information within the network that are associated with a predetermined type of traffic, such that the master upstream node operates as an exit node for the network with respect to the predetermined type of traffic, and wherein all packets of information that are associated with the predetermined type of traffic and that are transmitted by the traffic node are transmitted via the master upstream port.

23. The network of claim 22, wherein the predetermined type of traffic is selected from the group consisting of voice traffic, video traffic, data traffic, and Internet traffic.
